(19) United States
(12) Patent Application Publication
(10) Pub. No.: US 2013/0069864 A1
(43) Pub. Date: Mar. 21, 2013

(54) DISPLAY APPARATUS, DISPLAY METHOD, AND PROGRAM

(71) Applicants: Kazuyuki Hirooka, Gunma (JP); Tsutomu Nigami, Tokyo (JP)

(72) Inventors: Kazuyuki Hirooka, Gunma (JP); Tsutomu Nigami, Tokyo (JP)

(73) Assignee: SONY CORPORATION, Tokyo (JP)

(21) Appl. No.: 13/607,106

(22) Filed: Sep. 7, 2012

(30) Foreign Application Priority Data
Sep. 15, 2011 (JP) 2011-202167

(51) Int. Cl. G09G 5/00

(52) U.S. Cl. 345/156

(57) ABSTRACT

There is provided a display apparatus including an observation position detection unit for detecting an observation position of an observer, a generation phase determination portion for determining a generation phase for each viewpoint of a multi-viewpoint image for a plurality of viewpoints depending on the detected observation position, a multi-viewpoint image generation unit for generating a viewpoint image for each viewpoint from a predetermined image depending on the determined generation phase, a display device configured to include a display area having a plurality of pixels arranged thereon, for displaying the viewpoint image for each viewpoint such that the viewpoint image can be observed in each of a plurality of observation areas, and a light beam controller configured to be disposed in front of or behind the display device, for restricting a direction of light beams emitted from the display device or incident on the display device.

### CROSS REFERENCES TO RELATED APPLICATIONS

The present application claims priority to Japanese Priority Patent Application JP 2011-202167 filed in the Japan Patent Office on Sep. 15, 2011, the entire content of which is hereby incorporated by reference.

### BACKGROUND

The present application relates to a display apparatus, a display method, and a program. More particularly, the present application relates to a display apparatus, a display method, and a program capable of shifting an observation area with a high resolution.

In recent years, a display apparatus which can display stereoscopic images has become popular. As a method of displaying stereoscopic images, there has been known a parallax barrier method and a lenticular method which are naked-eye type techniques.

As an example, when an observer's position is changed from sitting down to standing while observing a stereoscopic image, the height of the line of sight of an observer is changed accordingly. This causes a viewpoint of the observer to be varied in the horizontal direction or the observer to watch a reverse viewing image. That is, a variation of a viewpoint image is happened. Therefore, there has been proposed a technique in which an observation area is shifted by detecting a head position of an observer and by changing images depending on the detected results (for example, refer to Japanese Patent Application Laid-Open Publication No. H09-233500 and Japanese Patent Application Laid-Open Publication No. 2007-94022).

Japanese Patent Application Laid-Open Publication No. H09-233500 discloses a technique in which an image is shifted on a pixel-by-pixel basis in the horizontal direction depending on a head position of an observer. In addition, Japanese Patent Application Laid-Open Publication No. 2007-94022 discloses a technique in which an image is shifted on a pixel-by-pixel basis in the vertical direction, and accordingly the image is shifted in the unit of 1/n pixel (where n is the number of viewpoints) in the horizontal direction.

### SUMMARY

However, in the related art, the image is shifted on a pixel-by-pixel basis or in the unit of 1/n pixel, and thus there was a limitation on the resolution of a shift amount of the observation area.

In order to enable an observer to observe appropriate stereoscopic images, it is desirable to shift an image with a finer resolution. Therefore, there has been a demand for a technique for adjusting a shift amount with the finer resolution.

The present application has been made in view of these circumstances, and can allow an observation area to be shifted with a high resolution.

According to an embodiment of the present application, there is provided a display apparatus including an observation position detection unit for detecting an observation position of an observer; a generation phase determination portion for determining a generation phase for each viewpoint of a multi-viewpoint image for a plurality of viewpoints depending on the detected observation position; a multi-viewpoint image generation unit for generating a viewpoint image for each viewpoint from a predetermined image depending on the determined generation phase; a display device configured to include a display area having a plurality of pixels arranged thereon, for displaying the viewpoint image for each viewpoint such that the viewpoint image can be observed in each of a plurality of observation areas; and a light beam controller configured to be disposed in front of or behind the display device, for restricting a direction of light beams emitted from the display device or incident on the display device.

The generation phase determination portion may determine the generation phase by calculating a correction amount in accordance with an amount of the observation position deviated from a reference position and by adding the correction amount to a predetermined generation phase for each viewpoint.

The display apparatus may further include a storage unit for storing an offset value based on an amount of disposition position of the light beam controller for the display device deviated from a desired position, wherein the generation phase determination portion may determine the generation phase on the basis of the stored offset value.

The display apparatus may further include an image acquisition unit for acquiring a first original image and a second original image, wherein the multi-viewpoint image generation unit may generate the viewpoint image for each viewpoint from the first original image and the second original image depending on the determined generation phase.

The observation position detection unit may detect a position of observer's head, face or eye region from a face image which is obtained by capturing the observer.

The light beam controller may be a slit array or a lens array.

The display apparatus may be configured as a stand-alone apparatus or as part of a larger system.

A display method or a program according to an embodiment of the present application is a display method or a program corresponding to the display apparatus according to the embodiment of the present application described above.

In the display apparatus, display method, and program according to an embodiment of the present application, an observation position of an observer is detected, a generation phase for each viewpoint of a multi-viewpoint image for a plurality of viewpoints is determined depending on the detected observation position, a viewpoint image for each viewpoint is generated from a predetermined image depending on the determined generation phase, the generated viewpoint image for each viewpoint is displayed on a display device, and the display device is configured to include a display area having a plurality of pixels arranged thereon and to enable the viewpoint image for each viewpoint to be observed in each of a plurality of observation areas.

According to the embodiments of the present application, an observation area can be shifted with a high resolution.

Additional features and advantages are described herein, and will be apparent from the following Detailed Description and the figures.

### BRIEF DESCRIPTION OF THE FIGURES

FIG. 1 is a diagram illustrating a display surface of a display apparatus according to an embodiment of the present application;

FIG. 2 is a diagram illustrating a relationship between each pixel of a display device and mask apertures;

FIG. 3 is a diagram illustrating a relationship between the line of sight direction of an observer and each viewpoint image;

FIG. 4 is a diagram illustrating the line of sight direction which varies depending on the height of an observation position of an observer;

FIG. 5 is a diagram illustrating the line of sight direction when an observer views the mask apertures from the front side;

FIG. 6 is a diagram illustrating the line of sight direction when an observer views in a higher observation position;

FIG. 7 is a diagram illustrating a principle of an embodiment of the present application;

FIG. 8 is a diagram illustrating a configuration of a display apparatus;

FIG. 9 is a flowchart illustrating a generation phase control process;

FIG. 10 is a diagram illustrating a standard state;

FIG. 11 is a diagram illustrating a state deviated from the standard state;

FIG. 12 is a diagram illustrating a method of calculating a generation phase of each viewpoint;

FIG. 13 is a diagram illustrating a detailed example of the method of calculating a generation phase of each viewpoint;

FIG. 14 is a diagram illustrating a relationship between observation areas when there is no position deviation;

FIG. 15 is a diagram illustrating a relationship between observation areas when there is position deviation;

FIG. 16 is a diagram illustrating a principle of an embodiment of the present application;

FIG. 17 is a diagram illustrating another configuration of the display apparatus;

FIG. 18 is a flowchart illustrating a barrier deviation correcting control process when manufacturing;

FIG. 19 is a diagram illustrating a state where a position is deviated;

FIG. 20 is a diagram illustrating a method of calculating a generation phase correction amount offset value;

FIG. 21 is a flowchart illustrating a barrier deviation correcting control process when using; and

FIG. 22 is a diagram illustrating an exemplary configuration of a computer embodying the present application.

### DETAILED DESCRIPTION

Hereinafter, preferred embodiments of the present disclosure will be described in detail with reference to the appended drawings. Note that, in this specification and the appended drawings, structural elements that have substantially the same function and structure are denoted with the same reference numerals, and repeated explanation of these structural elements is omitted.

Hereinafter, embodiments of the present application will be described with reference to the drawings.

### First Embodiment

<Principle of First Embodiment of the Present Application>

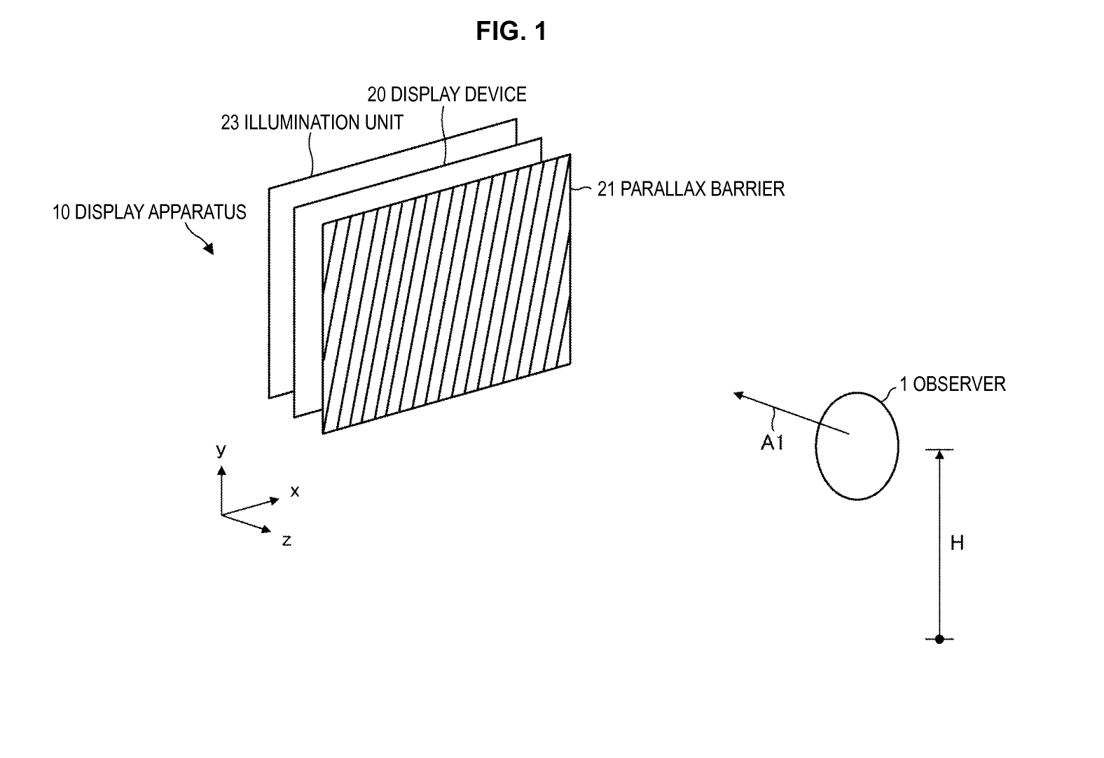

First, a principle of the first embodiment of the present application will be described with reference to FIGS. 1 to 7.

FIG. 1 illustrates a display surface of a display apparatus 10.

The display apparatus 10 is a stereoscopic image display apparatus which can realize naked-eye stereoscopic vision using a parallax barrier technique. On the display surface of the display apparatus 10, a display device 20 and a parallax barrier 21 are disposed with a predetermined gap therebetween.

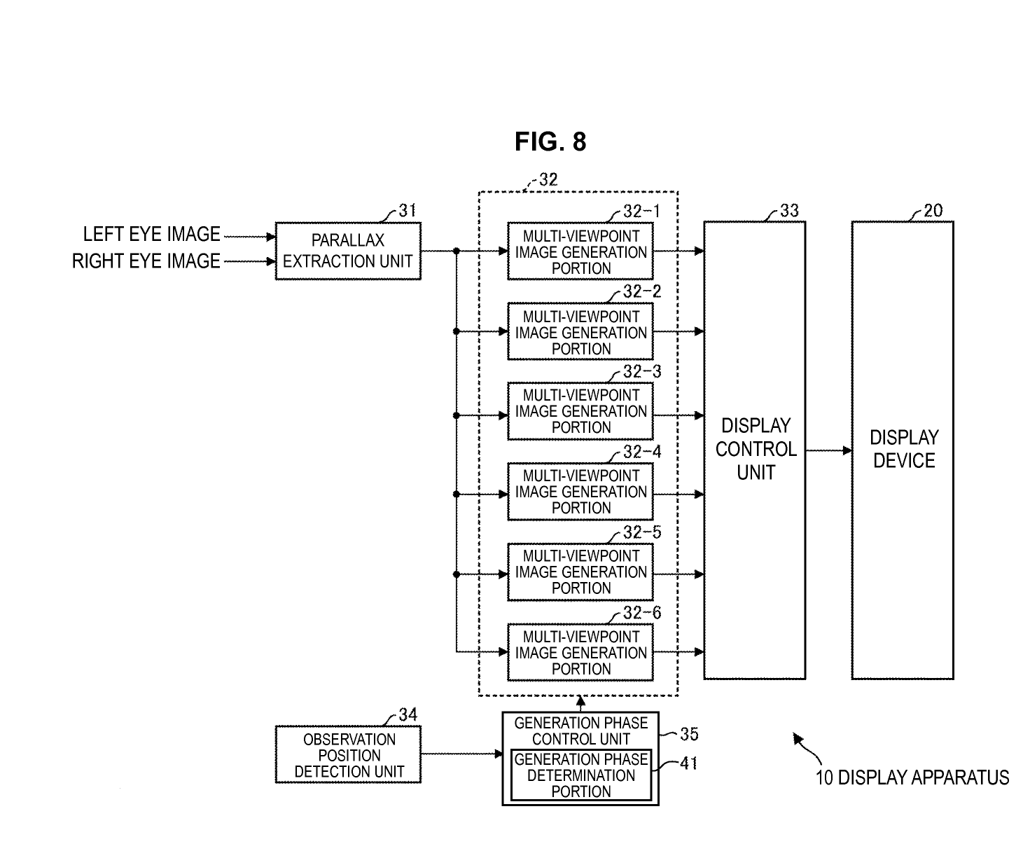

The display device 20 is configured to include, for example, a color liquid crystal panel. The display device 20 receives light from an illumination unit 23 and displays multi-viewpoint images for a user to view stereoscopic images. The stereoscopic images are supplied from a display control unit (for example, a display control unit 33 of FIG. 8 described later) at the previous stage.

The parallax barrier 21 is disposed in front of the display device 20 and restricts a direction of light beams emitted from the display device 20. The parallax barrier 21 is a shadow mask provided with a plurality of slit-shaped holes for transmitting light therethrough. Each pitch of the slits corresponds to a plurality of pixels. These slits give directionality to the light emitted from each pixel of the display device 20. Thus, an observer 1 can visually recognize stereoscopic images.

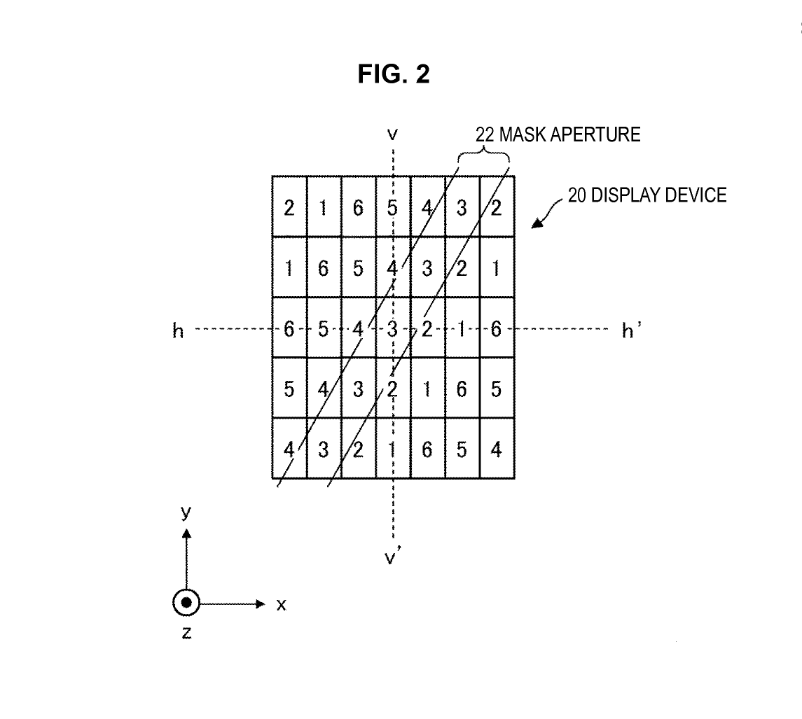

As shown in FIG. 2, the parallax barrier 21 includes mask apertures 22 formed to be continuously arranged in oblique direction of a pixel array of the display device 20. In addition, FIG. 2 illustrates an enlarged view of only some of the mask apertures 22 formed in the parallax barrier 21. Parts of the parallax barrier 21 other than the mask apertures 22 will be served as light blocking portions. The display device 20 has a display area in which a plurality of pixels are arranged. In FIG. 2, each of the number marked in the rectangle representing each pixel indicates a generation phase of a viewpoint image for each viewpoint. The observer 1 views any one of viewpoint images of the generation phases 1.0 to 6.0 with both the eyes, thereby observing stereoscopic images. In addition, the generation phase is a parameter which is designated when multi-viewpoint images having different phases are generated. A viewpoint image for each viewpoint is generated depending on a generation phase.

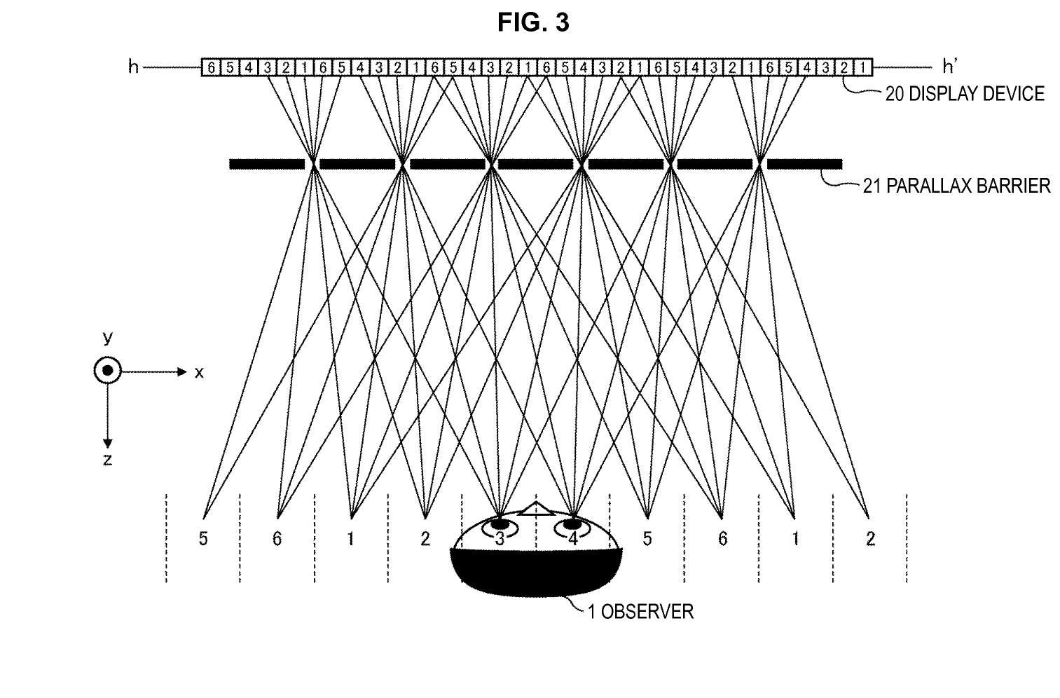

FIG. 3 shows a relationship between the line of sight direction of the observer 1 and each viewpoint image when the display apparatus 10 is viewed from the +y axis direction. As shown in FIG. 3, the observer 1, which is located approximately in the center with respect to the display surface of the display apparatus 10, views a viewpoint image of the generation phase 3.0 with the left eye and a viewpoint image of the generation phase 4.0 with the right eye among viewpoint images of the generation phases 1.0 to 6.0 displayed on the display device 20, thereby observing stereoscopic images. Each viewpoint image is viewed by the observer's eyes through the parallax barrier 21.

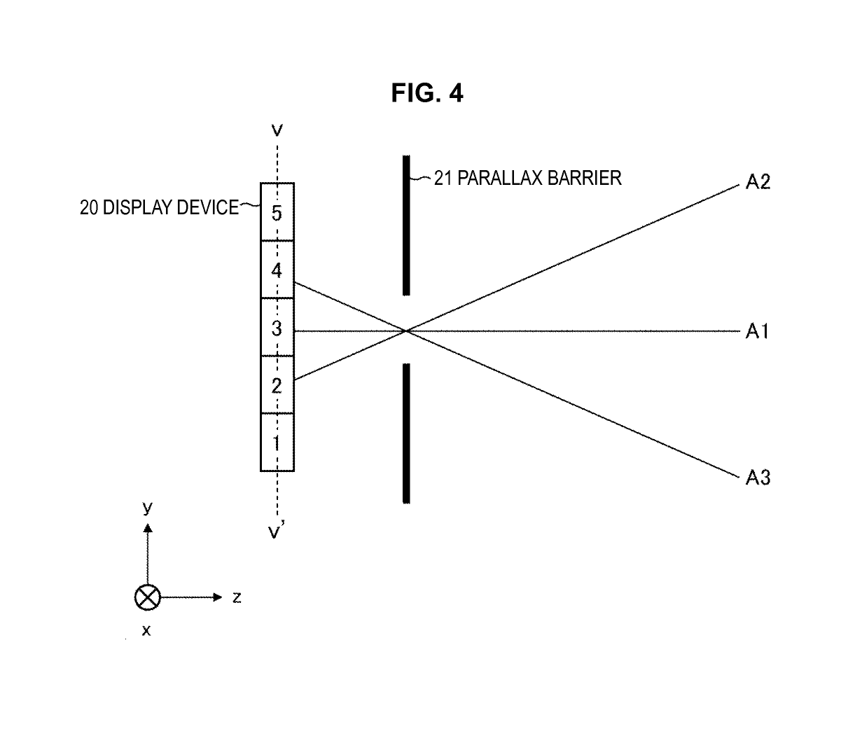

FIGS. 4 to 7 show a relationship between the line of sight direction of the observer 1 and each viewpoint image when the display apparatus 10 is viewed from the −x axis direction. In addition, some parts of the display device 20 and the parallax barrier 21 are shown enlarged in FIGS. 4 to 7, for convenience of description.

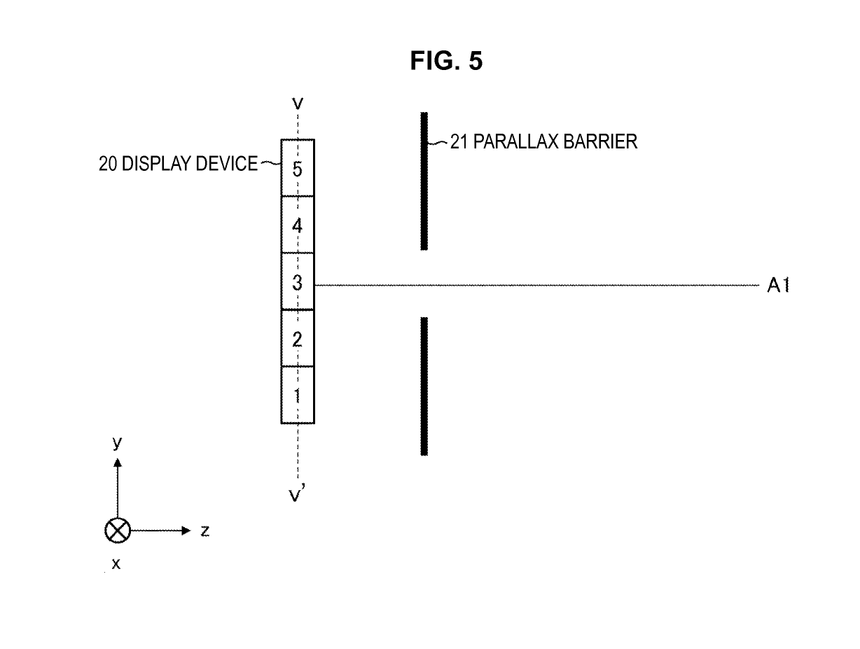

For the line of sight direction of the left eye of the observer 1, as an example shown in FIG. 4, three line of sight directions A1 to A3 may be considered according to the height of each observation position of the observer 1. For example, when the observer 1 is sitting down watching a program item displayed on the display apparatus 10 as shown in FIG. 1, the height of the observation position is H and the line of sight direction is A1. Accordingly, the observer's left eye views the viewpoint image of the generation phase 3.0 as shown in FIG. 5. In this case, when the observer 1 views the mask aperture 22 directly from the front side, the left eye views the viewpoint image of the generation phase 3.0 and the right eye views the viewpoint image of the generation phase 4.0, as shown in FIG. 3. Therefore, the observer can normally view stereoscopic images of the program item.

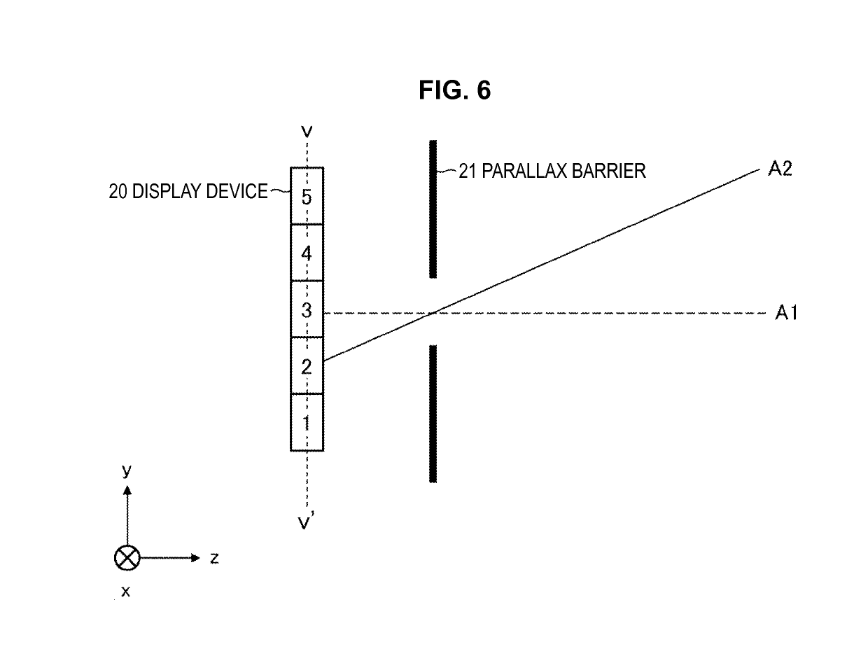

On the other hand, for example, when the position of the observer 1 is changed from sitting down to standing while watching the program item, the observation position becomes higher than H and the line of sight becomes A2. The observer's left eye thus views the viewpoint image of the generation phase 2.0, as shown in FIG. 6. In this case, the left eye of the observer 1 views the viewpoint image of the generation phase 2.0 located in the lower side of the generation phase 3.0, otherwise the left eye of the observer 1 would view the viewpoint image of the generation phase 3.0. Similarly, if the line of sight direction of the observer 1 becomes A3, the left eye of the observer 1 views the viewpoint image of the generation phase 4.0 located in the upper side of the generation phase 3.0, otherwise the left eye of the observer 1 would view the viewpoint image of the generation phase 3.0. In these cases, the observer 1 views the stereoscopic images from the left-leaning side or the right-leaning side, not the center of the observation area.

In other words, if the height of the observation position of the observer 1 is changed, viewpoints are changed accordingly, and thus the observer 1 feels discomfort. Alternatively, in a case where images which the observer 1 initially views are located on the left-leaning side or the right-leaning side within an observation area, an observation area is shifted by a change in observation position due to standing up or sitting down, and, as a result, not a normal viewing state but a reverse viewing state may be caused in some cases. Furthermore, the “reverse viewing” indicates that the combined viewpoint image where the depth of stereoscopic images is reversed is viewed with the left and right eyes. At this time, the observer 1 is not able to view normal stereoscopic images. On the other hand, a state of the combined viewpoint image where the depth of stereoscopic images is normally observed is referred to as a “normal viewing”.

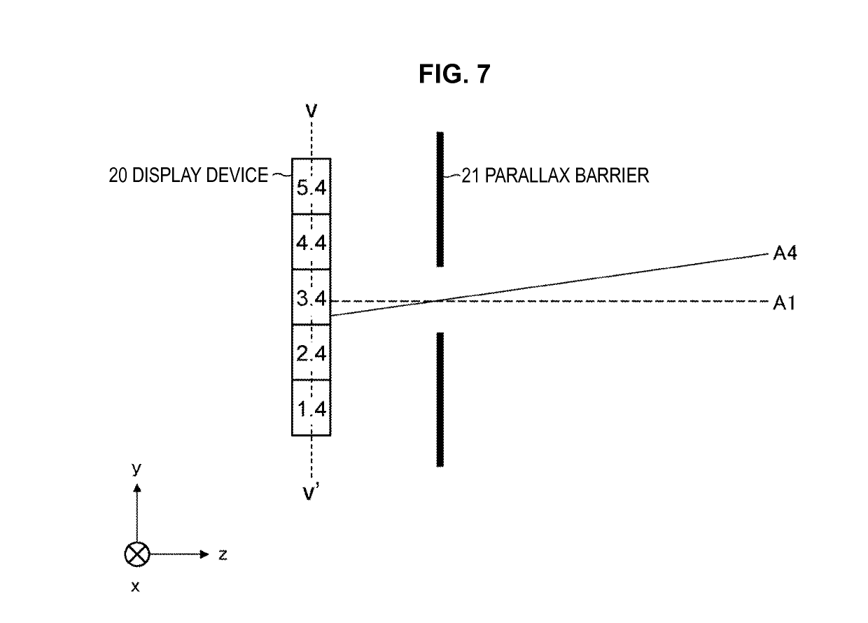

Therefore, according to the embodiment of the present application, an observation position of the observer 1 is detected, and a viewpoint image related to a generation phase which is changed depending on the detected result is displayed. For example, as shown in FIG. 7, in a case where the line of sight direction of the observer 1 becomes A4, the display apparatus 10 detects the height of the observer's observation position and determines a generation phase depending on the detected result. And then, the display apparatus 10 generates a multi-viewpoint image corresponding to the determined generation phase and displays the multi-viewpoint image on the display device 20. As a result, in the display device 20, a pixel, which has displayed the viewpoint image of the generation phase 3.0, will display a viewpoint image of the generation phase 3.4. In addition, in the similar manner, other pixels also display each viewpoint image where 0.4 is added to their respective generation phases.

The viewpoint image of the generation phase 3.0 is thus recognized as if it is viewed from the line of sight direction A4, and the viewpoints are not moved toward to the left or right side even when the observer 1 stands or sits down (that is, even if a viewing height is changed), thereby viewing stereoscopic images.

However, if another observer, who is different from the observer 1, observes from the line of sight direction A1 direction of FIG. 1, it is recognized that an observation area is moved to the left or right side. In this way, by shifting the observation area in the horizontal direction depending on a viewing height of the observer 1, the observation area for the observer 1 may not be shifted.

In addition, in FIG. 6, in a case where an image is shifted on a pixel-by-pixel basis, for example, each viewpoint image of the generation phases 1.0 to 5.0 displayed in each pixel of the display device 20 are shifted to each viewpoint images of the generation phases 2.0 to 6.0, but this is based on the fact that the viewpoint images are shifted one by one, and thus there is a limitation on the resolution of a shift amount of the observation area. On the other hand, according to the embodiment of the present application, an intermediate viewpoint image corresponding to an observation position of the observer 1 is generated in the stage of generating the respective viewpoint images, thus it is possible to shift an observation area with a higher resolution as compared with the case of being shifted on a pixel-by-pixel basis.

Hereinafter, a specific method of implementing the principle of the first embodiment of the present application will be described.

<Exemplary Configuration of Display Apparatus>

FIG. 8 is a diagram illustrating a configuration of the display apparatus according to the first embodiment.

The display apparatus 10 includes a display device 20, a parallax extraction unit 31, a multi-viewpoint image generation unit 32, a display control unit 33, an observation position detection unit 34, and a generation phase control unit 35. In addition, although not shown explicitly in the configuration of FIG. 8, the display apparatus 10 includes a parallax barrier 21 and an illumination unit 23.

The parallax extraction unit 31 acquires a left eye image and a right eye image which are input from an external device and extracts parallax information from the left eye image and the right eye image. The parallax extraction unit 31 supplies the left eye image, the right eye image, and the parallax information to the multi-viewpoint image generation unit 32.

In addition, images having a variety of data formats can be input from an external device, and any format of them may be used. For example, there are a form of being supplied as a stereo-image of the left eye image and the right eye image, a form of being supplied as a multi-viewpoint image formed by three or more viewpoint images, a form of being supplied as a two-dimensional image and parallax information thereof, and the like. In addition, the parallax information can be obtained by generating a deviation amount in the horizontal direction of a left eye image and a right eye image as a disparity map.

The multi-viewpoint image generation unit 32 generates a multi-viewpoint image (viewpoint image for each viewpoint) as an interpolation image of the left eye image and the right eye image, on the basis of the left eye image, the right eye image, and the parallax image supplied from the parallax extraction unit 31, and supplies the generated multi-viewpoint image to the display control unit 33. The multi-viewpoint image generation unit 32 includes a multi-viewpoint image generation portion 32-1 to a multi-viewpoint image generation portion 32-6.

The display control unit 33 causes the display device 20 to display the viewpoint image for each viewpoint supplied from the multi-viewpoint image generation unit 32.

As described above, the display device 20 includes a display area having a plurality of pixels disposed thereon. The display device 20 also displays the viewpoint image for each viewpoint supplied from the display control unit 33 such that the viewpoint image for each viewpoint can be observed in each of a plurality of observation area corresponding to each of the viewpoints. In addition, the parallax barrier 21 disposed in front of the display device 20 includes the mask aperture 22 which is continuously arranged in an oblique direction of the pixel array of the display device 20. The mask aperture 22 restricts a direction of light beams emitted from the display device 20. The display device 20 and the parallax barrier 21 are disposed with a predetermined gap therebetween.

The observation position detection unit 34 detects an observation position of the observer 1 and supplies the detected result to the generation phase control unit 35. For example, the observation position detection unit 34 includes an image pickup portion. The observation position detection unit 34 analyzes image data obtained by capturing the observer 1 and detects a position of the observer's head, face, or eye from a face image of the observer 1 as an observation position. As a method for this detection, well-known techniques disclosed in various documents may be used.

The generation phase control unit 35 performs a process for controlling a generation phase. Specifically, the generation phase control unit 35 includes a generation phase determination portion 41. The generation phase determination portion 41 determines a generation phase for each viewpoint of a multi-viewpoint image for a plurality of viewpoints, depending on the observation position supplied from the observation position detection unit 34. The generation phase control unit 35 supplies the generation phase for each viewpoint determined by the generation phase determination portion 41 to the multi-viewpoint image generation portion 32-1 to the multi-viewpoint image generation portion 32-6, respectively.

The multi-viewpoint image generation portion 32-1 to the multi-viewpoint image generation portion 32-6 respectively generate a viewpoint image for each viewpoint depending on the generation phase supplied from the generation phase control unit 35, and supplies the generated viewpoint image to the display control unit 33.

Furthermore, in the illustrated embodiment, although the configuration where the multi-viewpoint image generation portion 32-1 to the multi-viewpoint image generation portion 32-6 for generating each viewpoint image corresponding to six viewpoints is shown in order to describe an example of generating each viewpoint image of six viewpoints, this configuration is exemplary, and thus the number of the multi-viewpoint image generation portion 32 may be varied in correspondence to the number of viewpoints.

The configuration of the display apparatus 10 will be described below.

<Process of Controlling Generation Phase>

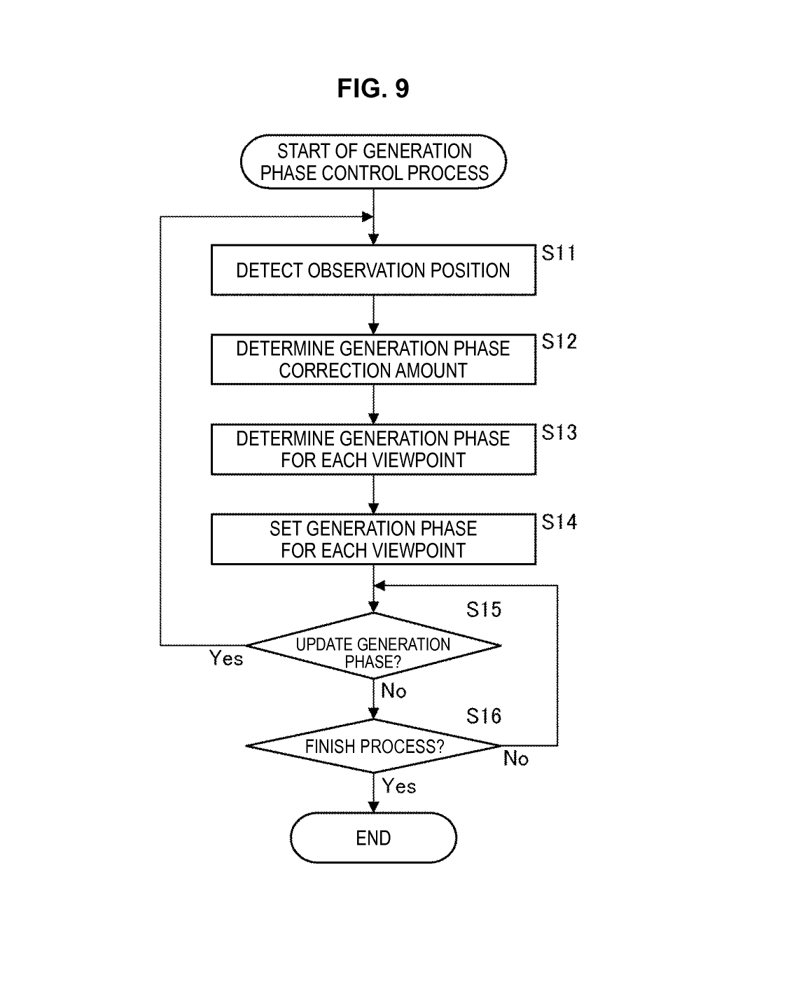

Referring to a flowchart of FIG. 9, a generation phase control process performed by the observation position detection unit 34 and the generation phase control unit 35 will be described.

In step S11, the observation position detection unit 34 detects an observation position of the observer 1.

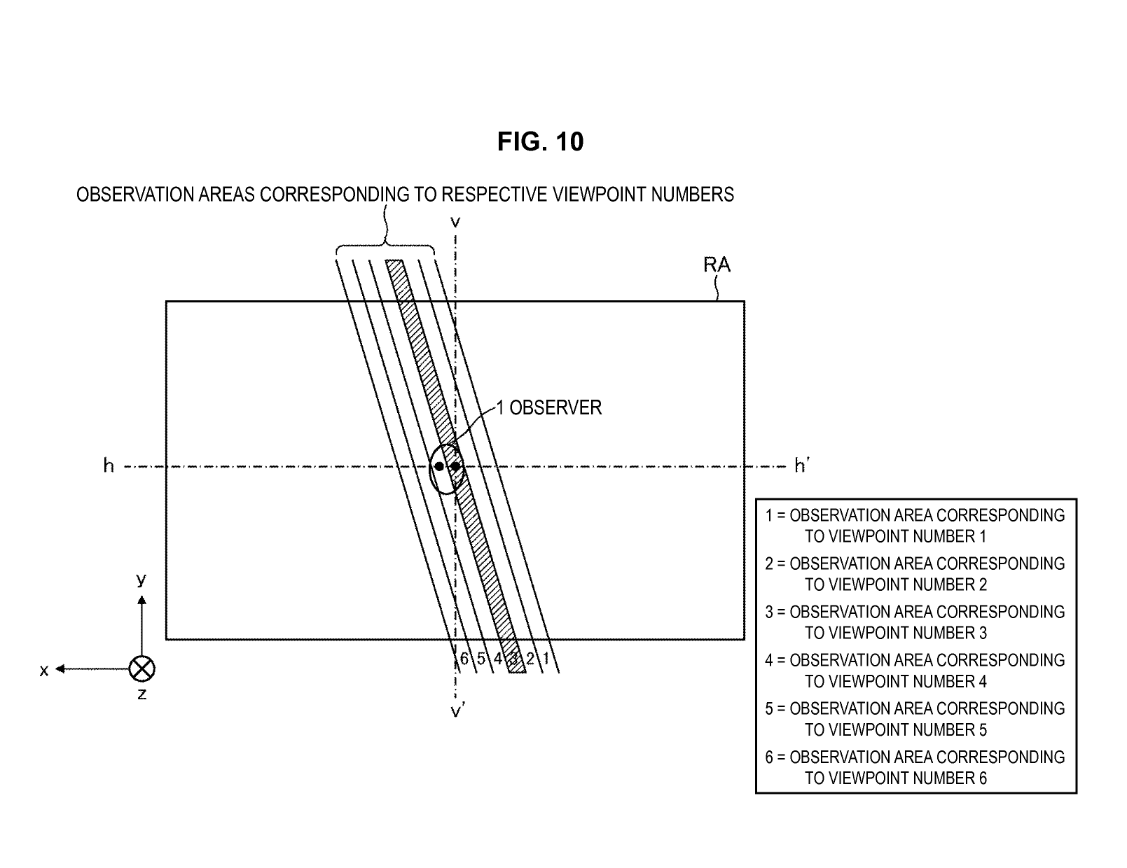

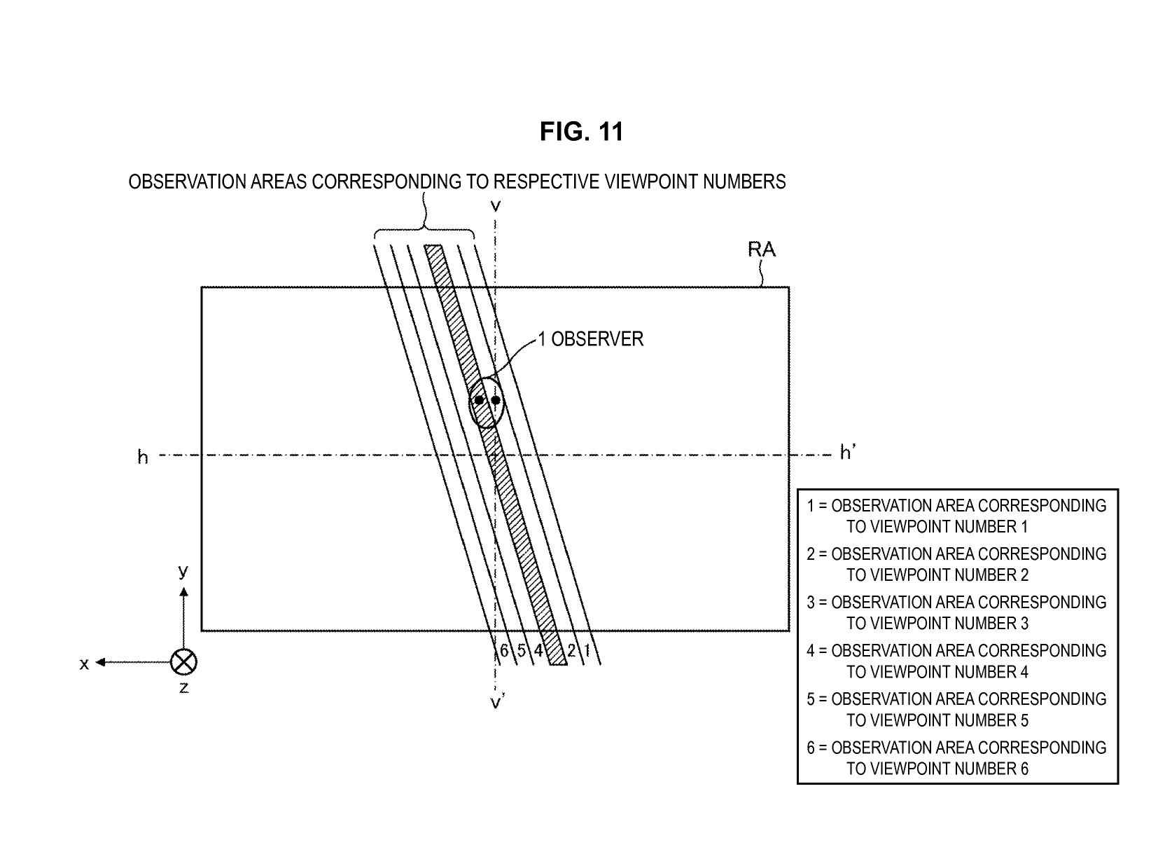

In this regard, a method of detecting an observation position of the observer 1 will be described in detail with reference to FIGS. 10 and 11.

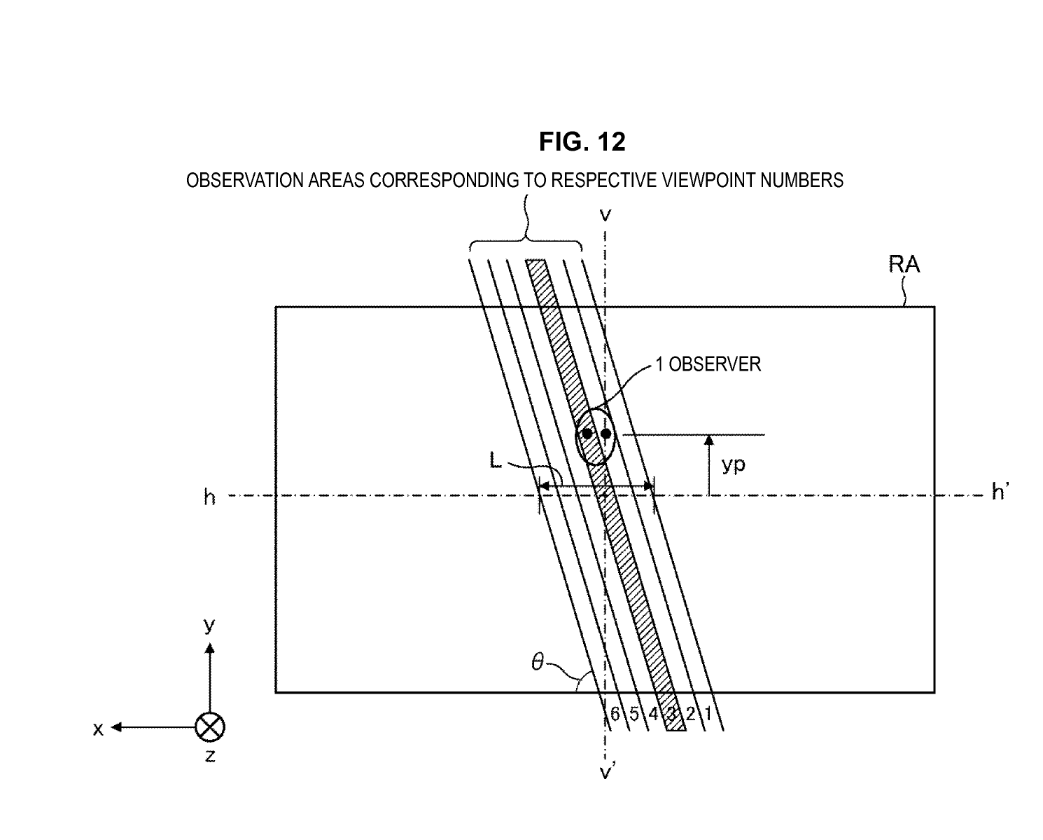

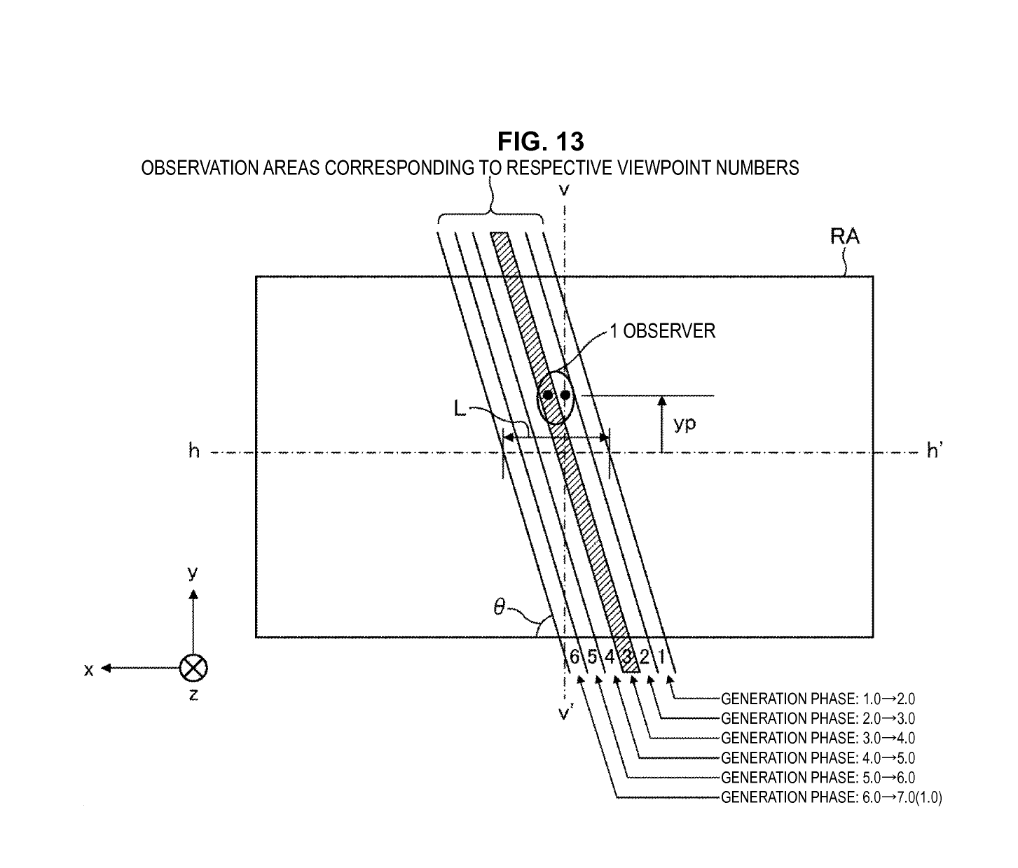

FIGS. 10 and 11 schematically illustrate a case where the observer 1 is viewed from the display surface side of the display apparatus 10. In addition, a rectangular area RA in the figures indicates a rectangular area in the x-y plane in an appropriate viewing distance d, and it is assumed that there is the observer 1 within the area. In addition, these are also similarly applied to FIGS. 12 and 13 described later.

Here, as shown in FIG. 10, for example, if a point at which the dotted line h-h′ in the horizontal direction on the display surface intersects the dotted line v-v′ in the vertical direction thereon is a center position (origin), a case where the left eye of the observer 1 exists at the center position is defined as a “standard state”. In addition, the numerals “1” to “6” in the figure respectively indicate corresponding observation areas of viewpoint images of the generation phases 1.0 to 6.0. Therefore, in a standard state, the observer 1 views the viewpoint image of the generation phase 3.0 with the left eye and views the viewpoint image of the generation phase 4.0 with the right eye, thereby observing stereoscopic images.

In addition, although the definition of the standard state may not be necessarily expected as being appropriate, the definition as described above is used for convenience of describing the principle of the embodiment of the present application. In addition, since the mask aperture 22 formed in the parallax barrier 21 is disposed in an oblique direction of the pixel array of the display device 20, the entire range (observation area) where the viewpoint image for each viewpoint is clearly observed is also correspondingly inclined.

Thereafter, for example, when an observation position is changed from the standard state of FIG. 10 into a state shown in FIG. 11, such as when the position of the observer 1 is changed from sitting down to standing up, the observer 1 views the viewpoint image of the generation phase 2.0 with the left eye and the viewpoint image of the generation phase 3.0 with the right eye. In this case, the observer 1 feels as viewpoints were moved in the horizontal direction as compared with the observation of the stereoscopic image in the standard state of FIG. 10.

The observation position detection unit 34 analyzes image data obtained by capturing the observer 1, and thus calculates coordinates (xo,yo,zo) of the left eye of the observer, for example, when the center of the display surface is used as the origin, from a face image of the observer 1. In addition, although the coordinates (xo,yo,zo) of the left eye of the observer 1 are defined as an observation position, various sites such as the center of the head or the center between the eyes may be defined as the standard state.

Referring again to the flowchart of FIG. 9, in step S12, the generation phase control unit 35 determines a generation phase correction amount (dphase) on the basis of the observation position detected in step S11. If step S12 finishes, then, in step S13, the generation phase determination portion 41 determines a generation phase (phase_i) for each viewpoint on the basis of the generation phase correction amount determined in step S12.

Here, referring to FIGS. 12 and 13, a method of determining a generation phase correction amount and a generation phase for each viewpoint will be described in detail.

As shown in FIG. 12, if coordinates where the observation position (xo,yo,zo) is projected onto the x-y plane in the appropriate viewing distance d are (xp,yp), then xp and yp are calculated according to Expression (1) below:

xp=xo×d/zo

yp=yo×d/zo (1)

In addition, if the length in the x axis direction of a normal viewing range of the observation area is L and an oblique angle of the observation area relative to the x axis is θ, the generation phase correction amount (dphase) is calculated according to Expression (2) below:

dphase=1.0×yp/(L×tan θ) (2)

In the above Expression (2), “1.0” is a constant determined by a relationship between the number of viewpoints and a generation phase. In other words, since a generation phase varies by 1.0 between adjacent viewpoints in the example shown in FIG. 12, the constant in Expression (2) is set to “1.0”. From this relationship, for example, the movement in the x axis direction by the length L causes the generation phase to be deviated by 6.0, and the movement in the y axis direction by the length (L×tan θ) causes the generation phase to be deviated by 6.0.

From the above, the generation phase correction amount is determined by the generation phase control unit 35 (step S12 of FIG. 9). Next, the generation phase determination portion 41 determines a generation phase for each viewpoint from the generation phase correction amount (step S13 of FIG. 9).

More specifically, the generation phase (phase_i) for each viewpoint is calculated according to Expression (3), assuming this is performed on the x-y plane of FIG. 12.

phase_{—}i=phase_std_{—}i+dphase (3)

(where i=1, 2, 3, . . . , 6)

In the Expression (3), phase_i indicates a generation phase of the viewpoint number i, and phase_sti_i indicates a generation phase in the standard state of the viewpoint number i. Further, dphase indicates a generation phase correction amount calculated according to the Expression (2).

For example, if an observation position is yp and yp/(L×tan θ) is 1.0, dphase=1.0(1.0×1.0=1.0) is obtained from the Expression (2). In this case, the generation phase phase_i for each viewpoint is obtained by adding 1.0 to the generation phase phase_std_i in the standard state.

As shown in FIG. 13, if i=2, phase_2=phase_std_2+dphase=2.0+1.0=3.0 is obtained according to the Expression (3). That is to say, the observer 1 views the viewpoint image of the generation phase 3.0 with the left eye. In addition, in relation to generation phases of other viewpoints, 2.0, 3.0, 4.0, 5.0, 6.0, and 7.0 (1.0) can be obtained as phase_i (where i=1, 2, 3, . . . , 6) by adding the generation phase correction amount in the similar way, and thus the observer views the viewpoint image of the generation phase 4.0 with the right eye. As a result, the observer 1 views the viewpoint image of the generation phase 3.0 with the left eye and views the viewpoint image of the generation phase 4.0 with the right eye. The observer thus can observe stereoscopic images which are the same as before the viewing height is changed.

In regard to the calculation of the generation phase for each viewpoint, there is a case where a value of phase_i is out of the range of the standard values 1.0 to 6.0 of the generation phase. In this case, it is regarded that the section of standard values 1.0 to 6.0 is repeated with respect to a portion exceeding a range of 0.5 to 6.5, and a correction value is obtained by adding or subtracting the calculated result to or from the range of the standard values 1.0 to 6.0 or the range of 0.5 to 6.5 including the range, and the correction value may be used as phase_i. Specifically, for example, if phase_i=7.0 is calculated, 6.0 is subtracted therefrom, and phase_i=1.0 is used. In addition, for example, if phase_i=0.0 is calculated, because phase_i is reduced from 1.0 by 1.0 and is to be a generation phase of the next repeated viewpoint number i, phase_i=6 is used.

In addition, for example, in a case where an observation position is yp/2, dphase=0.5 is obtained according to the Expression (2). In this case, a generation phase phase_i for each viewpoint is obtained by adding 0.5 to the generation phase phase_std_i in the standard state.

For example, if i=2, phase_2=phase_std_2+dphase=2.0+0.5=2.5 is obtained according to the Expression (3). In addition, for generation phases of other viewpoints, in the similar way, 1.5, 2.5, 3.5, 4.5, 5.5, and 6.5 can be obtained as phase_i (where i=1, 2, 3, . . . , 6) by adding the generation phase correction amount. As a result, the observer 1 views the viewpoint images of the generation phase 2.5 and generation phase 3.5 with the left eye and views the viewpoint images of the generation phase 3.5 and generation phase 4.5 with the right eye, and thus views the viewpoint image of the generation phase 3.0 with the left eye and the viewpoint image of the generation phase 4.0 with the right eye in an equivalent manner, thereby observing the same stereoscopic image as in a case of an observation position (height) yp=0.

Referring again to the flowchart of FIG. 9, in step S14, the generation phase control unit 35 sets the generation phases for the respective viewpoints determined in step S13 for the multi-viewpoint image generation portion 32-1 to the multi-viewpoint image generation portion 32-6, respectively. In addition, each of the multi-viewpoint image generation portion 32-1 to the multi-viewpoint image generation portion 32-6 generates a viewpoint image according to the generation phase which is set by the generation phase control unit 35. Specifically, for example, the multi-viewpoint image generation portion 32-1 generates a viewpoint image of the generation phase 2.0 according to the set generation phase 2.0. Similarly, the multi-viewpoint image generation portion 32-2 to the multi-viewpoint image generation portion 32-6 generate viewpoint images of the generation phases 3.0 to 7.0 (1.0) according to the generation phases 3.0 to 7.0 (1.0). The display control unit 33 displays each of the viewpoint images of the generation phases 2.0 to 7.0 (1.0) generated by the multi-viewpoint image generation portion 32-1 to the multi-viewpoint image generation portion 32-6 in predetermined pixels of the display device 20.

The observer 1, for example, stands to view the viewpoint image of the generation phase 3.0 with the left eye and view the viewpoint image of the generation phase 4.0 with the right eye. As a result, the observer 1 can observe the same stereoscopic images as before standing up.

In step S15, the generation phase control unit 35 judges whether or not the generation phase is updated. For example, the generation phase is updated in synchronization with a timing when images corresponding to one frame is input from an external device, and thus a viewpoint image for each viewpoint can be generated using a generation phase which is updated for each frame at all times when a multi-viewpoint image is generated. Alternatively, the update for each frame may not be performed by appropriately changing an update frequency of a generation phase. In addition, there may be settings in which an update frequency of a generation phase and a detection frequency of an observation position do not correspond with each other, for example, the detection of an observation position is performed every time, and the update of a generation phase is not performed every time. Further, when a generation phase is generated, as one method, the generation phase is used without any modification. As another method, the generation phase may be used after appropriate filtering such as an LPF (low-pass filter) is performed thereon.

If it is judged that the generation phase is updated in step S15, the flow returns to step S11, and the subsequent processes are repeatedly performed. In other words, in this case, the processes in steps Si i to S14 are repeatedly performed so as to update generation phases.

On the other hand, if it is judged that the generation phase is not updated in step S15, the flow proceeds to step S16. In step S16, the generation phase control unit 35 receives a signal resulting from, for example, powering-off of the display apparatus 10 by the observer 1, from a controller (not shown) of the entire system, and judges whether or not the process finishes.

In step S16, if it is judged that the process does not finish, the flow returns to step S15. That is to say, the judgment process in step S15 is repeatedly performed until a generation phase is updated (“Yes” in step S15) or the process finishes (“Yes” in step S16). In addition, if it is judged that the process is completed in step S16, the process finishes.

As above, the generation phase control process has been described with reference to FIG. 9.

In this way, in the generation phase control process, an observation position of the observer 1 is detected by the observation position detection unit 34, and a generation phase for each viewpoint is determined by the generation phase determination portion 41 depending on the detected observation position. In addition, a viewpoint image for each viewpoint is generated by the multi-viewpoint image generation unit 32 depending on the determined generation phase, and the generated viewpoint image for each viewpoint is displayed in predetermined pixels of the display device 20.

Thus, since an intermediate viewpoint image corresponding to an observation position of the observer 1 can be generated in the steps of generating the respective viewpoint images, it is possible to shift an observation area with a high resolution as compared with a case of being shifted on a pixel-by-pixel basis. In addition, since a generation phase is changed depending on an observation position of one observer, the embodiment of the present application is appropriately applied to a display apparatus which is not assumed to be used for a plurality of observers to observe.

### Second Embodiment

<Principle of Second Embodiment of the Present Application>

When the display apparatus 10 is manufactured, the display device 20 is aligned with the parallax barrier 21, and they are disposed at appropriate positions; however, if a disposition position of the parallax barrier 21 relative to the display device 20 is deviated from a desired position, an observation area is deviated. In this case, an observation area is different for each of manufactured display apparatus 10. Therefore, handling in a case where a position of the parallax barrier 21 is deviated will be described as the second embodiment.

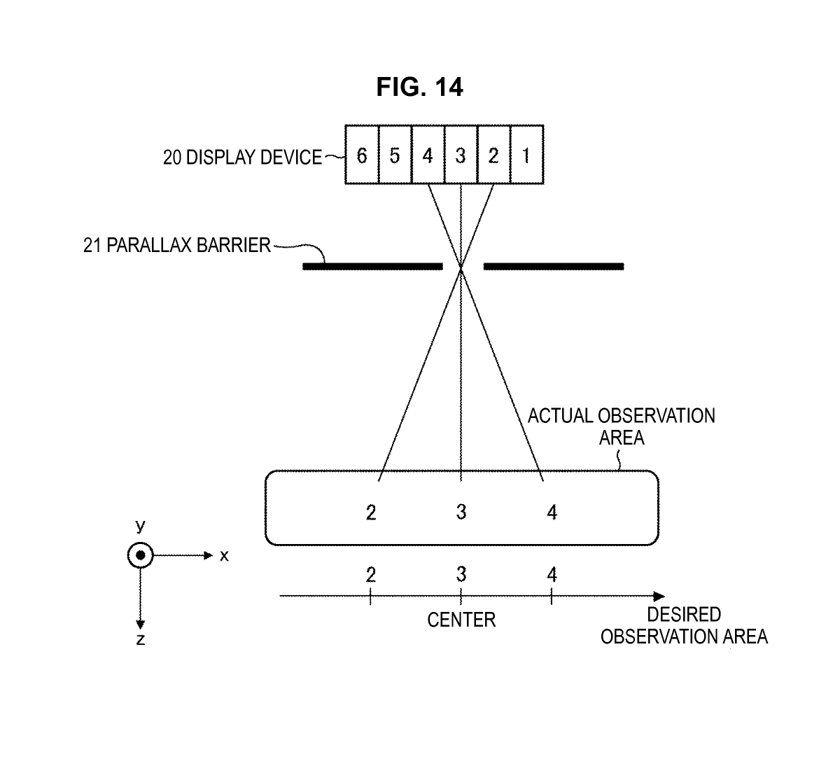

First, a principle of the second embodiment of the present application will be described with reference to FIGS. 14 to 16.

FIGS. 14 to 16 illustrates a relationship between a desired observation area and an actual observation area when the display apparatus 10 is viewed from the +y axis direction. In addition, in FIGS. 14 to 16, for convenience of description, some parts of the display device 20 and the parallax barrier 21 are shown so as to be enlarged.

As shown in FIG. 14, in a case where a position of the parallax barrier 21 is not deviated from the display device 20, a desired observation area corresponds with an actual observation area. For this reason, the observer 1 views the viewpoint image of the generation phase 3.0 with the left eye and views the viewpoint image of the generation phase 4.0 with the right eye via the parallax barrier 21 among the viewpoint images of the generation phases 1.0 to 6.0 displayed on the display device 20, thereby visually recognizing stereoscopic images.

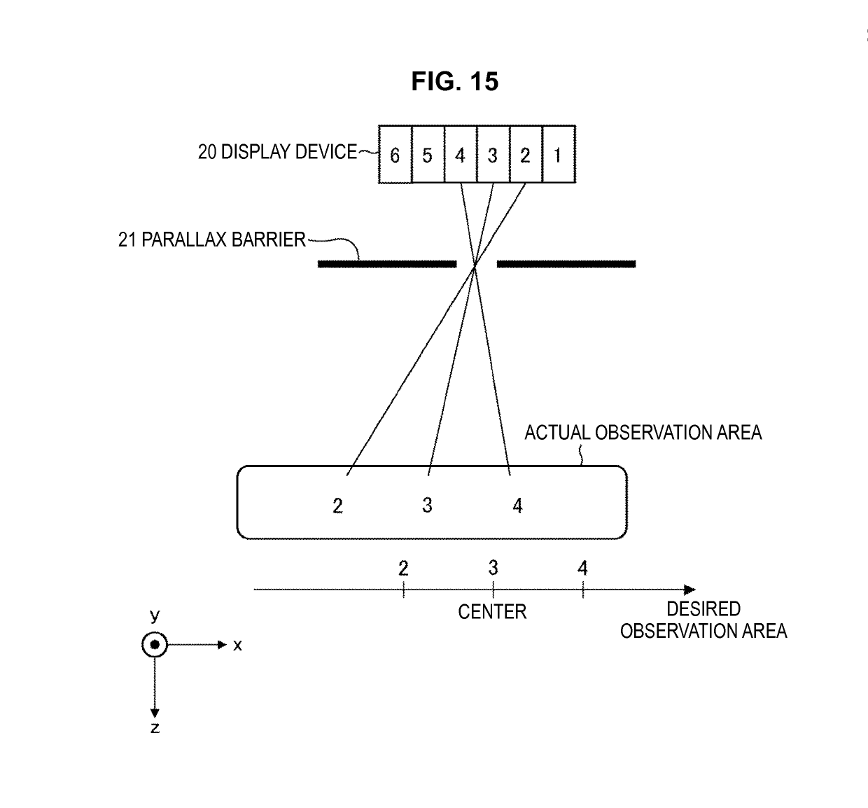

On the other hand, as shown in FIG. 15, in a case where a position of the parallax barrier 21 is deviated from the display device 20, the desired observation area is deviated from the actual observation area. Therefore, when the observer 1 observes the desired observation area, the observer originally views the viewpoint image of the generation phase 3.0 with the left eye and views the viewpoint image of the generation phase 4.0 with the right eye. However, the actual observation area is deviated leftward due to the position deviation of the parallax barrier 21, and stereoscopic images which are viewed from the right side slightly as compared with the case in FIG. 14 are visually recognized.

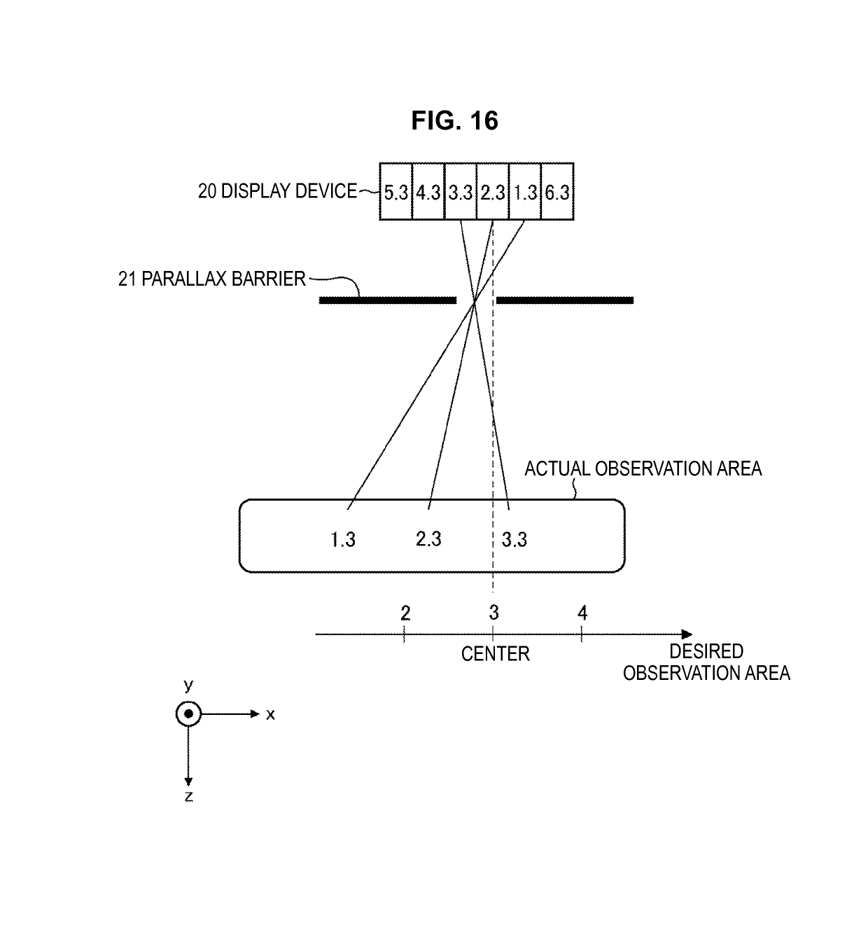

In other words, if a position of the parallax barrier 21 is deviated, a position of the observation area varies depending thereon, and thus a position of a desired observation area which is determined as a standard specification of products is not maintained constant for all the products. Therefore, in the embodiment of the present application, by deviating the generation phase of each viewpoint image displayed in the pixels of the display device 20, an actual observation area is made to correspond with a desired observation area in an equivalent manner. For example, as shown in FIG. 16, if a viewpoint image of the generation phase 3.0 is to be presented to the left eye of the observer 1, a position deviation amount of the parallax barrier 21 is measured, and a viewpoint image of the generation phase 2.3 is displayed in pixels which have displayed the viewpoint image of the generation phase 3.0 in FIG. 14 on the basis of the measured result. In the similar manner, each of viewpoint images of which a generation phase is subtracted by 0.7 is displayed in other pixels.

Thus, a viewpoint image which is observed at a position of the “center” indicated by the dotted line in the figure is not the viewpoint image of the generation phase 3.0; however, each viewpoint image is displayed such that a position at which the viewpoint image of the generation phase 3.0 is to be viewed in the actual observation area corresponds with that in the desired observation area. As a result, the observer 1 can observe the same stereoscopic images as in FIG. 14.

Hereinafter, a detailed realization method of the second embodiment of the present application will be described.

<Configuration Example of Display Apparatus>

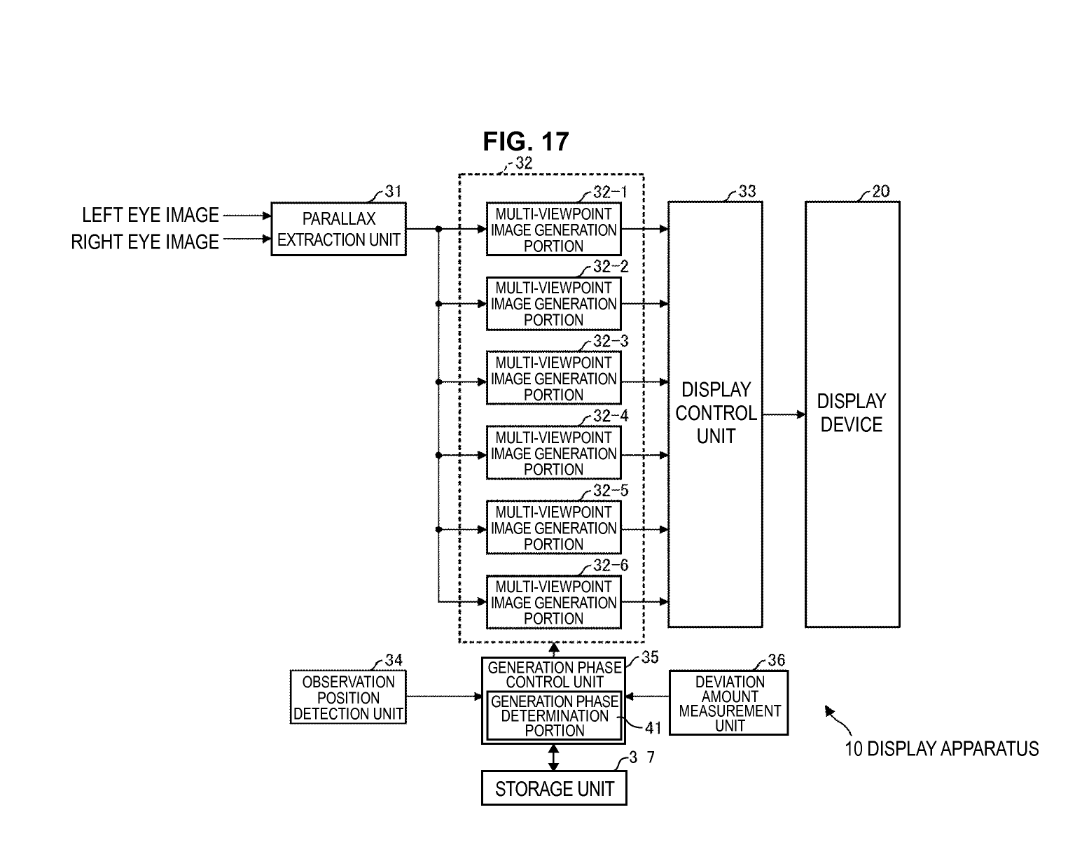

FIG. 17 is a diagram illustrating a configuration of the display apparatus according to the second embodiment.

In addition, in FIG. 17, the elements corresponding to those in FIG. 8 are given the same reference numerals, and description thereof will be appropriately omitted.

In other words, the display apparatus 10 in FIG. 17 is further provided with a deviation amount measurement unit 36 and a storage unit 37, in addition to the display apparatus 10 of FIG. 8.

The deviation amount measurement unit 36 measures a deviation amount indicating an amount of a disposition position of the parallax barrier 21 which is deviated from its desired position relative to the display device 20. The deviation amount measurement unit 36 supplies the deviation amount to the generation phase control unit 35. In addition, there will be described a case where the deviation amount measurement unit 36 is an internal component of the display apparatus 10, but the deviation amount measurement unit may be a deviation amount measurement device configured as an external device and be connected to the display apparatus 10.

The generation phase control unit 35 determines a generation phase correction amount offset value on the basis of the measured value (deviation amount) obtained from the deviation amount measurement unit 36 and causes the storage unit 37 to store the determined generation phase correction amount offset value. In addition, the generation phase determination portion 41 reads out the generation phase correction amount offset value from the storage unit 37 when determining a generation phase, and determines a generation phase for each viewpoint depending on an observation position and the generation phase correction amount offset value.

The configuration of the display apparatus 10 has been described.

<Barrier Deviation Correcting Control Process when Manufacturing>

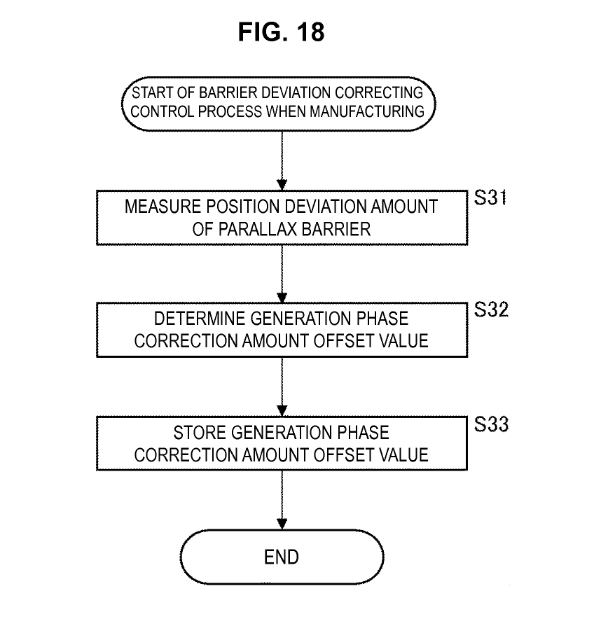

Next, referring to a flowchart of FIG. 18, a description will be provided of a barrier deviation correcting control process when manufacturing. The barrier deviation correcting control process is performed by the generation phase control unit 35 and the deviation amount measurement unit 36.

In step S31, the deviation amount measurement unit 36 measures a position deviation amount (dbar) of the parallax barrier 21.

In addition, as a method of measuring a position deviation amount dbar of the parallax barrier 21, for example, after the display apparatus 10 is manufactured, an image where only a viewpoint image corresponding to the viewpoint number 3 is white and viewpoint images corresponding to other viewpoint numbers are black is displayed on the display device 20. And then, the image is captured using the image pickup unit, and a position of a portion where the entire screen is black is obtained, thereby measuring the position deviation amount.

In step S32, the generation phase control unit 35 determines a generation phase correction amount offset value (dphase_ofst) on the basis of the position deviation amount measured in step S31.

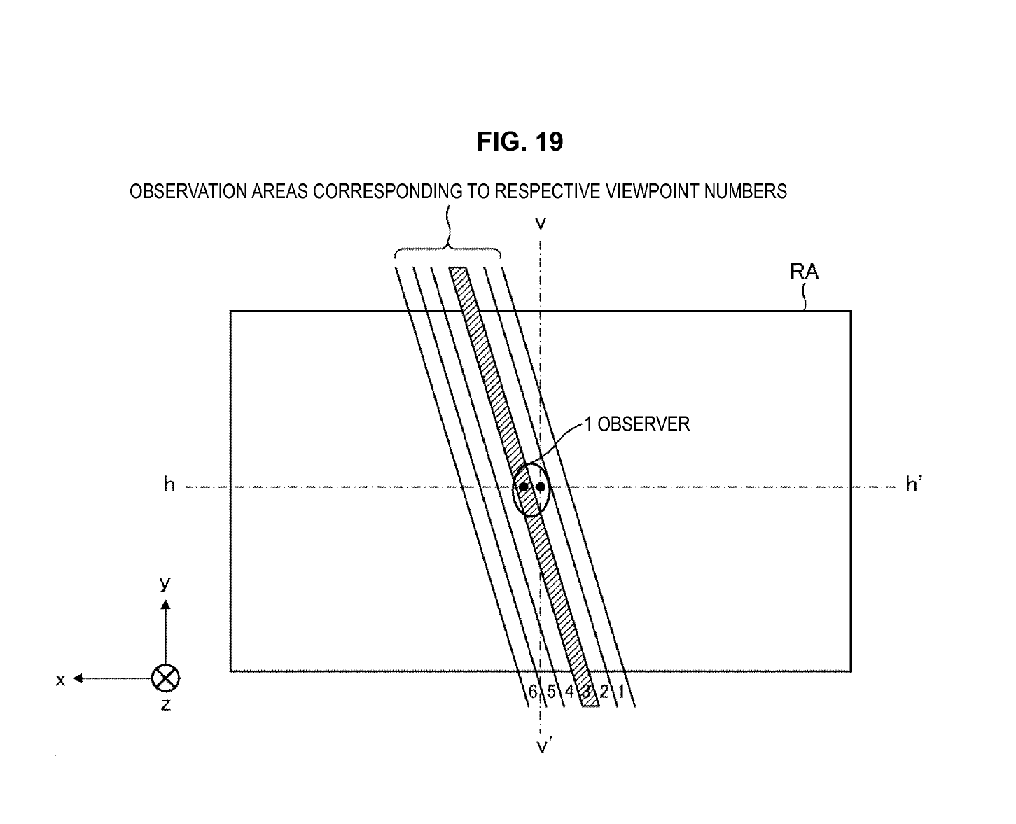

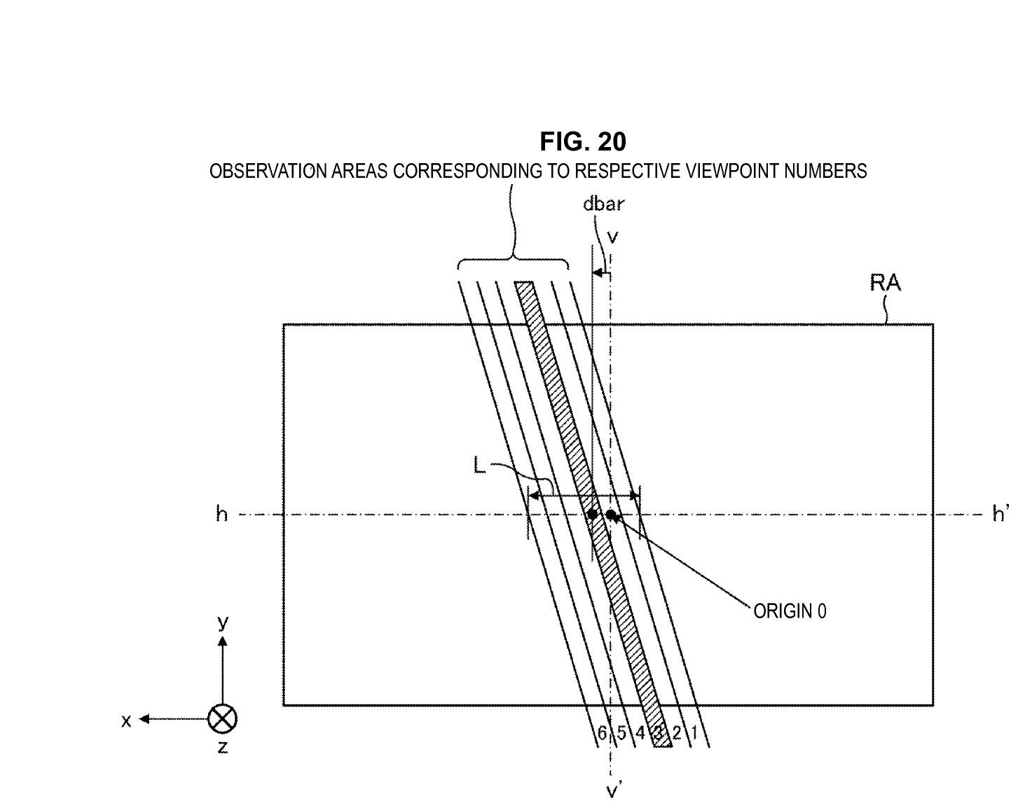

A method of determining a generation phase correction amount offset value will be described in detail with reference to FIGS. 19 and 20. In addition, FIGS. 19 and 20 schematically show a case where the observer 1 is viewed from the display surface side of the display apparatus 10, as with FIGS. 10 to 13 described above.

FIG. 19 shows a state where the deviation is made in the +x axis direction by only an observation area corresponding to a single viewpoint number since a position of the parallax barrier 21 is deviated, as compared with FIGS. 10 to 13. In addition, in FIG. 19, for convenience of description, a case where deviation occurs by an observation area corresponding to a single viewpoint number will be described.

In this case, the observer 1 views the viewpoint image of the generation phase 2.0 with the left eye and views the viewpoint image of the generation phase 3.0 with the right eye, and thus recognizes that viewpoints are deviated in the horizontal direction as compared with the standard state shown in FIG. 10. In other words, if a position of the parallax barrier 21 is deviated, the overall observation areas are deviated in response to the deviation.

In addition, as shown in FIG. 20, if an amount deviated from the origin of the center of the observation area corresponding to the viewpoint number 3 is dbar and a length in the x axis direction of a normal viewing range of the observation areas is L, a generation phase correction amount offset value (dphase_ofst) is calculated according to Expression (4).

dphase_ofst=1.0×dbar/L (4)

In addition, in the Expression (4), dbar indicates a value measured by the deviation amount measurement unit 36 in step S31. In addition, “1.0” in the Expression (4) is a constant which is set by a relationship between the number of viewpoints and a generation phase in the same way as the above Expression (2), and, since a generation phase varies by 1.0 between adjacent viewpoints in the example shown in FIGS. 19 and 20 as well, the constant in the Expression (4) is set to “1.0”.

Referring again to the flowchart of FIG. 18, in step S33, the generation phase control unit 35 stores the generation phase correction amount offset value determined in step S32 in the storage unit 37. If step S33 is completed, the process finishes.

As above, the barrier deviation correcting control process when manufacturing of FIG. 18 has been described.

In this way, in the barrier deviation correcting control process when manufacturing, a position deviation amount of the parallax barrier 21 is measured by the generation phase control unit 35. A generation phase correction amount offset value corresponding to the measured position deviation amount is determined by the deviation amount measurement unit 36 and is stored in the storage unit 37.

Thus, even in a case where a position of the parallax barrier 21 is deviated from the display device 20, it is possible to correct a generation phase by the use of the generation phase correction amount offset value stored in the storage unit 37.

<Barrier Deviation Correcting Control Process when Using>

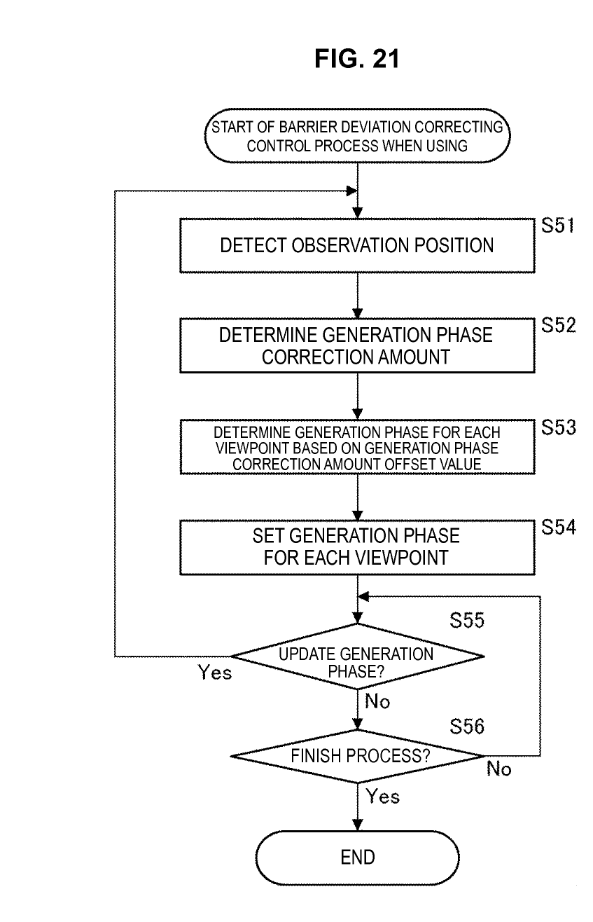

Next, referring to a flowchart of FIG. 21, a description will be provided of a barrier deviation correcting control process when using. The barrier deviation correcting control process is performed by the generation phase control unit 35.

In steps S51 and S52, an observation position of the observer 1 is measured by the observation position detection unit 34, and a generation phase correction amount is determined by the generation phase control unit 35, as with steps S11 and S12 of FIG. 9.

In step S53, the generation phase determination portion 41 reads out the generation phase correction amount offset value stored in the storage unit 37 in step S33 of FIG. 18, and determines a generation phase for each viewpoint depending on both the observation position and the generation phase correction amount offset value.

Specifically, a generation phase (phase_i) for each viewpoint is calculated according to Expression (5) below:

phase_{—}i=phase_std_{—}i+dphase+dphase_ofst (5)

(where i=1, 2, 3, . . . , 6)

In addition, in the Expression (5), in the similar way as the Expression (3), phase_i indicates a generation phase of the viewpoint number i, and phase_sti_i indicates a generation phase in the standard state of the viewpoint number i. Further, dphase indicates a generation phase correction amount which is calculated according to the Expression (2). In addition, dphase_ofst indicates the generation phase correction amount offset value which is stored in the storage unit 37.

In step S54, in the similar way as step S14 of FIG. 9, the generation phase control unit 35 sets the generation phase for each viewpoint determined in step S53 in the multi-viewpoint image generation portion 32-1 to the multi-viewpoint image generation portion 32-6. In addition, each of the multi-viewpoint image generation portion 32-1 to the multi-viewpoint image generation portion 32-6 generates a viewpoint image according to the generation phase set by the generation phase control unit 35.

In steps S55 and S56, in the similar way as steps S15 and S16 of FIG. 9, if it is judged that the generation phase is updated, the processes in steps S51 to S54 are repeatedly performed. In step S56, if it is judged that the process finishes by powering off the display apparatus 10 or the like, the process finishes.

As above, the barrier deviation correcting control process when using in FIG. 21 has been described.

In this way, in the barrier deviation correcting control process when using, an observation position of the observer 1 is detected by the observation position detection unit 34, and a generation phase for each viewpoint is determined by the generation phase determination portion 41 according to both the observation position and the generation phase correction amount offset value. In addition, a viewpoint image for each viewpoint is generated by the multi-viewpoint image generation unit 32 depending on the determined generation phase, and the generated viewpoint image for each viewpoint is displayed in predetermined pixels of the display device 20.

Thus, even in a case where a position of the parallax barrier 21 is deviated from the display device 20 and an observation area is different for each of manufactured display apparatus 10 in this state, a viewpoint image for viewpoint is generated by the use of a generation phase corrected using a generation phase correction amount offset value. And thus, a position of an observation area determined as a standard specification of products can be maintained constant for all the products.

### Modified Examples

Although, in the above description, for example, as shown in FIG. 1, the example where the parallax barrier 21 is disposed on the front side (+z axis direction) of the display device 20 has been described, the parallax barrier 21 may be disposed between the display device 20 and the illumination unit 23. In other words, the parallax barrier 21 is disposed in front of or behind the display device 20. The parallax barrier 21 also can restrict light beams emitted from the display device 20 or incident on the display device 20.

In addition, although, in the above description, the example where the mask aperture 22 is formed in an oblique direction of the pixel array of the display device 20 has been described, the mask aperture 22 may be formed so as to extend in the vertical direction with respect to the pixel array of the display device 20. In addition, although, in the above description, the parallax barrier method using the parallax barrier 21 as a light beam controller has been described as an example, a lenticular method using a lenticular lens may be employed.

<Computer Employing the Present Application>

A series of the above-described processes may be performed by hardware, or alternatively, may be performed by software. In the latter case, programs constituting the software are installed on a general purpose personal computer or the like.

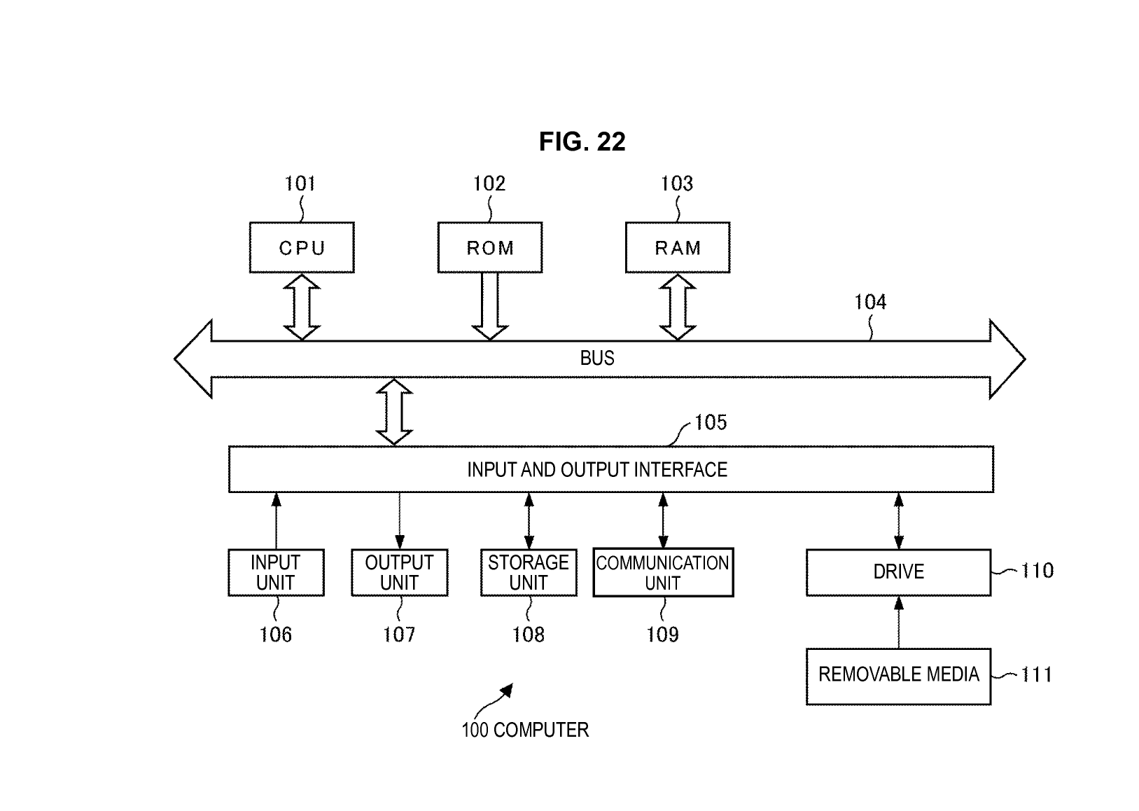

FIG. 22 shows a configuration example of the computer according to an embodiment on which a program for executing the above-described series of processes is installed.

The program may be stored in advance in a ROM (Read Only Memory) 102 or a storage unit 108 such as a hard disk embedded in the computer 100.

Alternatively, the program may be temporarily or permanently stored (recorded) in a removable medium 111 such as a flexible disk, a CD-ROM (Compact Disc Read Only Memory), an MO (Magneto Optical) disc, a DVD (Digital Versatile Disc), a magnetic disk, or a semiconductor memory. The removable medium 111 may be provided as so-called package software.

Furthermore, in addition to a case where the program is installed onto the computer 100 from the removable medium 111 as described above, the program may be transmitted to the computer 100 in a wireless manner via an artificial satellite for digital satellite broadcasting from the download site, or transmitted to the computer 100 in a wired manner via a network such as a LAN (Local Area Network) or the Internet, and the computer 100 may receive the program transmitted in this way using a communication unit 109 and install the program on the storage unit 108.

The computer 100 has a CPU (Central Processing Unit) 101 embedded therein. The CPU 101 is connected to an input and output interface 105 via a bus 104. When an input unit 106 including a keyboard, a mouse, a microphone, and the like is operated by a user and thus a command is input via the input and output interface 105, the CPU 101 executes the program stored in the ROM 102 in response thereto. Alternatively, the CPU 101 loads a program stored in the storage unit 108, a program which is transmitted from a satellite or a network, is received by the communication unit 109, and is installed onto the storage unit 108, or a program which is read from the removable medium 111 installed onto a drive 110 and is installed onto the storage unit 108, to a RAM (random access memory) 103, and executes the program.

Thus, the CPU 101 executes the processes according to the above-described flowchart or processes performed by the above-described configuration of the block diagram. In addition, the CPU 101 outputs the processed result, for example, from an output unit 107 including an LCD (Liquid Crystal Display), a speaker, and the like, transmits the processed result from the communication unit 109, or stores the processed result in the storage unit 108, via the input and output interface 105, as necessary.

Further, in this specification, the steps for describing a programs causing the computer 100 to perform various processes include not only processes performed in a time series according to the order described as a flowchart, but also processes performed in parallel or separately (for example, parallel processes, or processes using objects).

In addition, the program may be processed by a single computer, or may be processed a plurality of distributed computers. In addition, the program may be transmitted to and executed on a remote computer.

It should be understood by those skilled in the art that various modifications, combinations, sub-combinations and alterations may occur depending on design requirements and other factors insofar as they are within the scope of the appended claims or the equivalents thereof.

Additionally, the present application may also be configured as below.

(1) A display apparatus including:

an observation position detection unit for detecting an observation position of an observer;

a generation phase determination portion for determining a generation phase for each viewpoint of a multi-viewpoint image for a plurality of viewpoints depending on the detected observation position;

a multi-viewpoint image generation unit for generating a viewpoint image for each viewpoint from a predetermined image depending on the determined generation phase;

a display device configured to include a display area having a plurality of pixels arranged thereon, for displaying the viewpoint image for each viewpoint such that the viewpoint image can be observed in each of a plurality of observation areas; and

a light beam controller configured to be disposed in front of or behind the display device, for restricting a direction of light beams emitted from the display device or incident on the display device.

(2) The display apparatus according to (1), wherein the generation phase determination portion determines the generation phase by calculating a correction amount corresponding to an amount of the observation position deviated from a reference position and by adding the correction amount to a predetermined generation phase for each viewpoint.
(3) The display apparatus according to (1) or (2), further including:

a storage unit for storing an offset value based on an amount of a disposition position of the light beam controller deviated from a desired position relative to the display device,

wherein the generation phase determination portion determines the generation phase on the basis of the stored offset value.

(4) The display apparatus according to any of (1) to (3), further including:

an image acquisition unit for acquiring a first original image and a second original image,

wherein the multi-viewpoint image generation unit generates the viewpoint image for each viewpoint from the first original image and the second original image depending on the determined generation phase.

(5) The display apparatus according to any of (1) to (4), wherein the observation position detection unit detects a position of a head, face or eye region from a face image obtained by capturing the observer.
(6) The display apparatus according to any of (1) to (5), wherein the light beam controller is a slit array or a lens array.
(7) A display method performed by a display apparatus, the display method including:

detecting an observation position of an observer;

determining a generation phase for each viewpoint of a multi-viewpoint image for a plurality of viewpoints depending on the detected observation position;

generating a viewpoint image for each viewpoint from a predetermined image depending on the determined generation phase; and

displaying the generated viewpoint image for each viewpoint on a display device, the display device being configured to include a display area having a plurality of pixels arranged thereon and to enable the viewpoint image for each viewpoint to be observed in each of a plurality of observation areas.

(8) A program causing a computer to function as:

an observation position detection unit for detecting an observation position of an observer;

a generation phase determination portion for determining a generation phase for each viewpoint of a multi-viewpoint image for a plurality of viewpoints depending on the detected observation position;

a multi-viewpoint image generation unit for generating a viewpoint image for each viewpoint from a predetermined image depending on the determined generation phase; and

a display control unit for displaying the generated viewpoint image for each viewpoint on a display device, the display device being configured to include a display area having a plurality of pixels arranged thereon and to enable the viewpoint image for each viewpoint to be observed in each of a plurality of observation areas.

It should be understood that various changes and modifications to the presently preferred embodiments described herein will be apparent to those skilled in the art. Such changes and modifications can be made without departing from the spirit and scope of the present subject matter and without diminishing its intended advantages. It is therefore intended that such changes and modifications be covered by the appended claims.

The invention is claimed as follows:

1. A display apparatus comprising:
an observation position detection unit for detecting an observation position of an observer;
a generation phase determination portion for determining a generation phase for each viewpoint of a multi-viewpoint image for a plurality of viewpoints depending on the detected observation position;
a multi-viewpoint image generation unit for generating a viewpoint image for each viewpoint from a predetermined image depending on the determined generation phase;
a display device configured to include a display area having a plurality of pixels arranged thereon, for displaying the viewpoint image for each viewpoint such that the viewpoint image can be observed in each of a plurality of observation areas; and
a light beam controller configured to be disposed in front of or behind the display device, for restricting a direction of light beams emitted from the display device or incident on the display device.

2. The display apparatus according to claim 1, wherein the generation phase determination portion determines the generation phase by calculating a correction amount corresponding to an amount of the observation position deviated from a reference position and by adding the correction amount to a predetermined generation phase for each viewpoint.

3. The display apparatus according to claim 1, further comprising:
a storage unit for storing an offset value based on an amount of a disposition position of the light beam controller deviated from a desired position relative to the display device,
wherein the generation phase determination portion determines the generation phase on the basis of the stored offset value.

4. The display apparatus according to claim 1, further comprising:
an image acquisition unit for acquiring a first original image and a second original image,
wherein the multi-viewpoint image generation unit generates the viewpoint image for each viewpoint from the first original image and the second original image depending on the determined generation phase.

5. The display apparatus according to claim 1, wherein the observation position detection unit detects a position of a head, face or eye region from a face image obtained by capturing the observer.

6. The display apparatus according to claim 1, wherein the light beam controller is a slit array or a lens array.

7. A display method performed by a display apparatus, the display method comprising:
detecting an observation position of an observer;
determining a generation phase for each viewpoint of a multi-viewpoint image for a plurality of viewpoints depending on the detected observation position;
generating a viewpoint image for each viewpoint from a predetermined image depending on the determined generation phase; and
displaying the generated viewpoint image for each viewpoint on a display device, the display device being configured to include a display area having a plurality of pixels arranged thereon and to enable the viewpoint image for each viewpoint to be observed in each of a plurality of observation areas.

8. A program causing a computer to function as:
an observation position detection unit for detecting an observation position of an observer;
a generation phase determination portion for determining a generation phase for each viewpoint of a multi-viewpoint image for a plurality of viewpoints depending on the detected observation position;
a multi-viewpoint image generation unit for generating a viewpoint image for each viewpoint from a predetermined image depending on the determined generation phase; and
a display control unit for displaying the generated viewpoint image for each viewpoint on a display device, the display device being configured to include a display area having a plurality of pixels arranged thereon and to enable the viewpoint image for each viewpoint to be observed in each of a plurality of observation areas.
